(19) United States
(12) Patent Application Publication
(10) Pub. No.: US 2021/0173837 A1
(43) Pub. Date: Jun. 10, 2021

(54) GENERATING FOLLOWUP QUESTIONS FOR INTERPRETABLE RECURSIVE MULTI-HOP QUESTION ANSWERING

(71) Applicant: NEC Laboratories America, Inc., Princeton, NJ (US)

(72) Inventors: Christopher Malon, Fort Lee, NJ (US); Bing Bai, Princeton, NJ (US)

(21) Appl. No.: 17/109,781

(22) Filed: Dec. 2, 2020

Related U.S. Application Data
(60) Provisional application No. 62/944,383, filed on Dec. 6, 2019.

(51) Int. Cl. G06F 16/2452; G06N 3/08; G06N 3/04

(52) U.S. Cl. CPC G06F 16/24522; G06N 3/04; G06N 3/08

(57) ABSTRACT

A computer-implemented method is provided for generating following up questions for multi-hop bridge-type question answering. The method includes retrieving a premise for an input multi-hop bridge-type question. The method further includes assigning, by a three-way neural network based controller, a classification of the premise against the input multi-hop bridge-type question as being any of irrelevant, including a final answer, or including intermediate information. The method also includes outputting the final answer in relation to a first hop of the multi-hop bridge-type question responsive to the classification being including the final answer. The method additionally includes generating a followup question by a neural network and repeating said retrieving, assigning, outputting and generating steps for the followup question, responsive to the classification being including the intermediate information.

### RELATED APPLICATION INFORMATION

This application claims priority to U.S. Provisional patent Application No. 62/944,383, filed on Dec. 6, 2019, incorporated herein by reference entirety.

### BACKGROUND

### Technical Field

The present invention relates to question and answer systems and more particularly to generating follow-up questions for interpretable recursive multi-hop question answering.

### Description of the Related Art

State-of-art Question Answering (QA) techniques rely on a combination of (keyword-based) Information Retrieval (IR) and neural network based text extraction. The IR system retrieves a number of candidate sentences (also known as evidence) that may include the answers, and the text extraction system identifies the answer text in the evidence. However, for complicated (so-called “multi-hop”) questions, the original question does not include keywords needed to retrieve evidence that includes the answer, making straightforward QA fail in the IR stage. The problem is to answer these questions in an interpretable way, including the creation of followup queries given a question and partial evidence.

### SUMMARY

According to aspects of the present invention, a computer-implemented method is provided for generating following up questions for multi-hop bridge-type question answering. The method includes retrieving a premise for an input multi-hop bridge-type question. The method further includes assigning, by a three-way neural network based controller, a classification of the premise against the input multi-hop bridge-type question as being any of irrelevant, including a final answer, or including intermediate information. The method also includes outputting the final answer in relation to a first hop of the multi-hop bridge-type question responsive to the classification being including the final answer. The method additionally includes generating a followup question by a neural network and repeating said retrieving, assigning, outputting and generating steps for the followup question, responsive to the classification being including the intermediate information.

According to other aspects of the present invention, a computer program product is provided for generating following up questions for multi-hop bridge-type question answering. The computer program product includes a non-transitory computer readable storage medium having program instructions embodied therewith. The program instructions are executable by a computer to cause the computer to perform a method. The method includes retrieving a premise for an input multi-hop bridge-type question. The method further includes assigning, by a three-way neural network based controller, a classification of the premise against the input multi-hop bridge-type question as being any of irrelevant, including a final answer, or including intermediate information. The method also includes outputting the final answer in relation to a first hop of the multi-hop bridge-type question responsive to the classification being including the final answer. The method additionally includes generating a followup question by a neural network and repeating said retrieving, assigning, outputting and generating steps for the followup question, responsive to the classification being including the intermediate information.

According to yet other aspects of the present invention, a computer processing system is provided for generating following up questions for multi-hop bridge-type question answering. The computer processing system includes a memory device for storing program code. The computer processing system further includes a processor device, operatively coupled to the memory device, for running the program code to retrieve a premise for an input multi-hop bridge-type question. The processor device further runs the program code to assign, using a three-way neural network based controller, a classification of the premise against the input multi-hop bridge-type question as being any of irrelevant, including a final answer, or including intermediate information. The processor device also runs the program code to output the final answer in relation to a first hop of the multi-hop bridge-type question responsive to the classification being including the final answer. The processor device additionally runs the program code to generate a followup question using a neural network and repeat the running of the program code for the followup question, responsive to the classification being including the intermediate information.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing a multi-hop bridge-type questions recursive answer pipeline, in accordance with embodiment of the present invention;

FIG. 3 is a flow diagram showing an exemplary application method for generating followup questions for interpretable recursive multi-hop question answering, in accordance with an embodiment of the present invention;

FIGS. 4-5 are flow diagrams showing an exemplary training method for generating followup questions for interpretable recursive multi-hop question answering, in accordance with an embodiment of the present invention;

FIG. 6 is a block diagram showing an exemplary educational environment to which the present invention can be applied, in accordance with an embodiment of the present invention; and

FIG. 7 is a block diagram showing an exemplary computing environment, in accordance with an embodiment of the present invention.

### DETAILED DESCRIPTION OF PREFERRED EMBODIMENTS

Embodiments of the present invention are directed to generating follow-up questions for interpretable recursive multi-hop question answering.

Embodiments of the present invention can determine an answer to a question and can further generate followup questions as well as answer the followup questions. In this way, further knowledge can be imparted on a given subject.

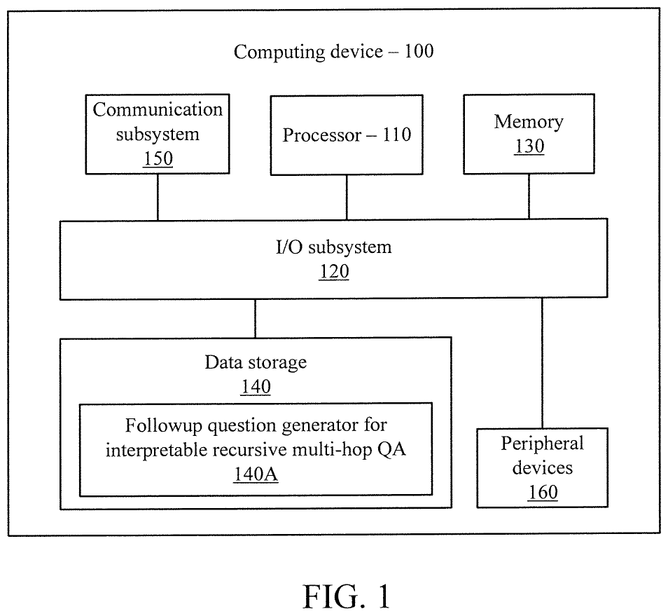

FIG. 1 is a block diagram showing an exemplary computing device 100, in accordance with an embodiment of the present invention. The computing device 100 is configured to generate followup questions for interpretable recursive multi-hop question answering.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for followup question generator for interpretable recursive multi-hop Question Answering (QA). The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. Further, in another embodiment, a cloud configuration can be used. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

A description will now be given of types of questions to which the present invention can be applied, in accordance with an embodiment of the present invention.

The present invention can be used for bridge-type questions. A bridge-type question is one such that it may not be possible to retrieve all the necessary facts based on the terms present in the original question alone. Rather, partial information must first be retrieved and used to formulate an additional query.

The present invention is designed to address the challenge of discovering new information that is not specified by the terms of the original question. At the highest level, comparison-type questions do not pose this challenge, because each quantity to be compared is specified by part of the original question. They also pose different semantics than bridge questions because a comparison must be applied after retrieving answers to the sub-questions. Therefore, a focus is made herein on bridge-type questions.

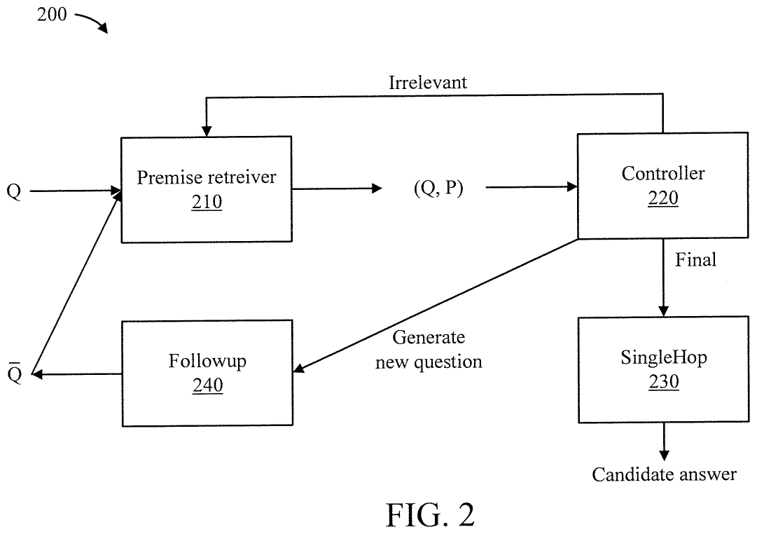

FIG. 2 is a block diagram showing a pipeline for answering multi-hop bridge-type questions 200, in accordance with embodiment of the present invention.

The pipeline 200 includes a premise retriever 210, a three-way neural network based controller (hereinafter interchangeably referred to as “controller” or “Cont”) 220, an answer extractor (hereinafter interchangeably referred to as “SingleHop”) 230, and a followup question generator (hereinafter interchangeably referred to as “Followup”) 240.

As partial information is obtained, an original question is iteratively reduced to simpler questions generated at each hop. Given an input question or sub-question, possible premises which may answer the sub-question are obtained from premise retriever 210. Each possible premise is classified against the question as irrelevant, including a final answer, or including intermediate information, by the three-way neural network based controller 220. For premises that include a final answer, the answer is extracted with a single hop question answering extractor SingleHop. For premises that include intermediate information, a question generator produces a followup question, and the process may be repeated with respect to this new question. It is this question generator that is a focus of the present invention. To that end various strategies may be used to manage the multiple reasoning paths that may be produced by the controller.

Although our method applies to bridge questions with arbitrary numbers of hops, for simplicity one or more illustrative embodiments of the present invention will be directed to two-hop problems and on training the followup question generator. Let Q₁ be a question with answer A and gold supporting premises \hat{P}₁ and \hat{P}₂, and suppose that \hat{P}₂ but not \hat{P}₁ includes the answer. The task of the followup generator 240 is to use Q1 and \hat{P}₁ to generate a followup question Q₂ such that

SingleHop(Q₂,\hat{P}₂)=A (1)

Cont(Q₂,\hat{P}₂)=Final (2)

and

Cont(Q₂,P)=Irrel for P≠P₂ (3)

One non-interpretable implementation of the pipeline would be for Followup 240 to simply output Q₁ concatenated with P₁ as the “followup question.” Then SingleHop 230 would operate on input that really does not take the form of a single question, along with P₂, to determine the final answer. Then SingleHop 230 would be doing multi-hop reasoning. To avoid such trivialities, SingleHop 230 is first trained as a single-hop answer extractor, then frozen while Followup 240 and Cont are trained.

A further description will now be given of a method, in accordance with an embodiment of the present invention.

Ideally, Followup 240 might be trained using cross entropy losses inspired by Equations (1), (2), and (3) with SingleHop 230 and Cont fixed, but the decoded output Q₂ is not differentiable with respect to Followup parameters. Instead, Followup 240 is trained with a token-based loss against a set of weakly labeled ground truth followup questions.

The weakly labeled ground truth followups are obtained using a neural question generation (QG) network. Given a context Ć and an answer Á, QG is the task of finding a question

\acute{Q}=argmax_{Q}Prob(Q|C,Á) (4)

most likely to have produced it. A single-hop question answering dataset, used in reverse (predicting questions from answers and contexts) is used to train the QG model. Applied to our training set with Ć=\hat{P}₂ and Á=A, it gives us a weak ground truth followup \acute{Q}₂.

We instantiate the followup question generator Followup 240, which uses Q and P₁ to predict Q₂, with a pointer generator network. This is a sequence to sequence model whose decoder repeatedly chooses between generating a word from a fixed vocabulary and copying a word from the input. Typically, pointer-generator networks are used for abstractive summarization. Although the output serves a different role here, their copy mechanism is useful in constructing a followup that uses information from the original question and premise.

We train Cont 220 with cross-entropy loss for ternary classification on the ground truth triples (Q₁, \hat{P}₁, Intermediate), (Q₁, \hat{P}₂, Final) if SingleHopQ₁, \hat{P}₂)∩A≠0, and (Q₁, P, Irrel) for all other P. In one implementation, Cont 220 is implemented by a neural network including multiple self-attention layers.

In this way, Cont 220 learns to predict when a premise has sufficient or necessary information to answer a question.

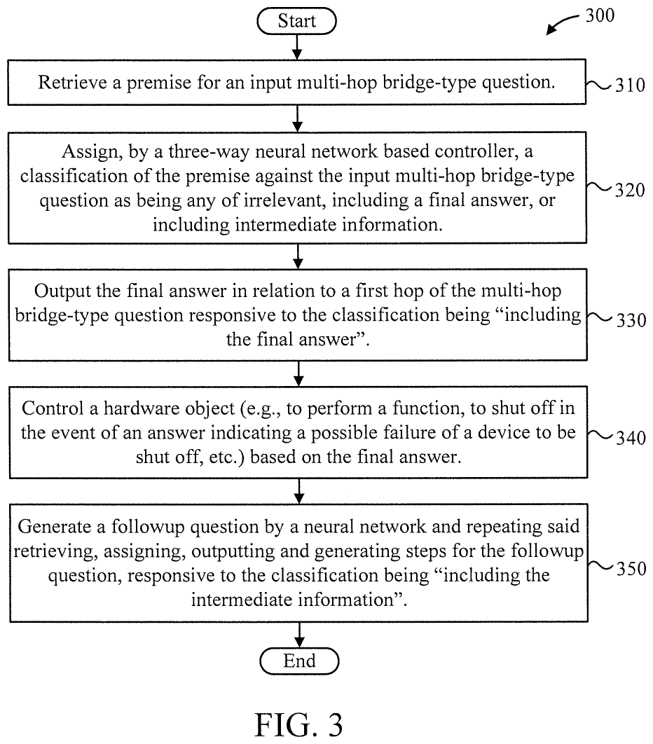

FIG. 3 is a flow diagram showing an exemplary application method 300 for generating followup questions for interpretable recursive multi-hop question answering, in accordance with an embodiment of the present invention.

At block 310, retrieve a premise for an input multi-hop bridge-type question.

At block 320, assign, by a three-way neural network based controller, a classification of the premise against the input multi-hop bridge-type question as being any of irrelevant, including a final answer, or including intermediate information.

At block 330, output the final answer in relation to a first hop of the multi-hop bridge-type question responsive to the classification being “including the final answer”.

At block 340, control a hardware object (e.g., to perform a function, to shut off in the event of an answer indicating a possible failure of a device to be shut off, etc.) based on the final answer (per block 330). For example, the questions can be for identification, at which point upon a user being identified, access control may be granted to a facility, a computer, or other hardware device. In an embodiment, block 340 can involve, for example, transforming an object from a first state to a second state different from the first state. Different states can involve operating states or other states as readily appreciated by one of ordinary skill in the art.

At block 350, generate a followup question by a neural network and repeating said retrieving, assigning, outputting and generating steps for the followup question, responsive to the classification being “including the intermediate information”.

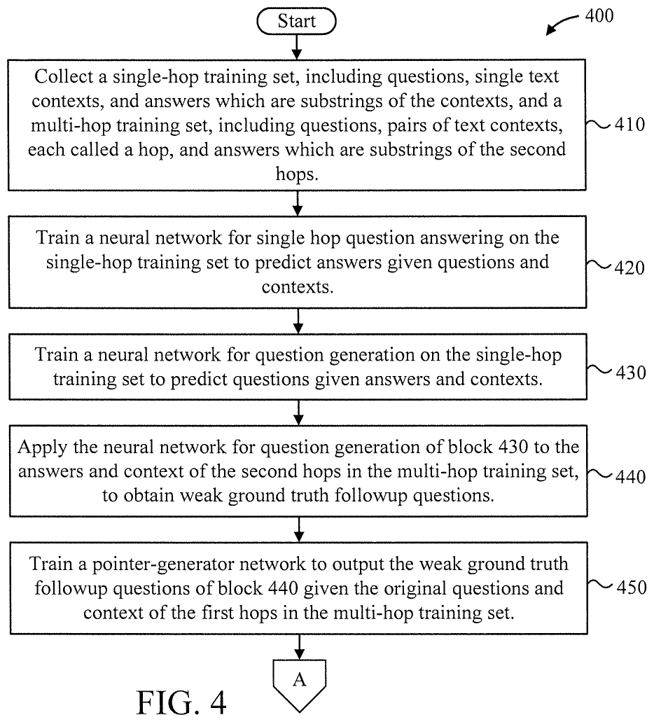

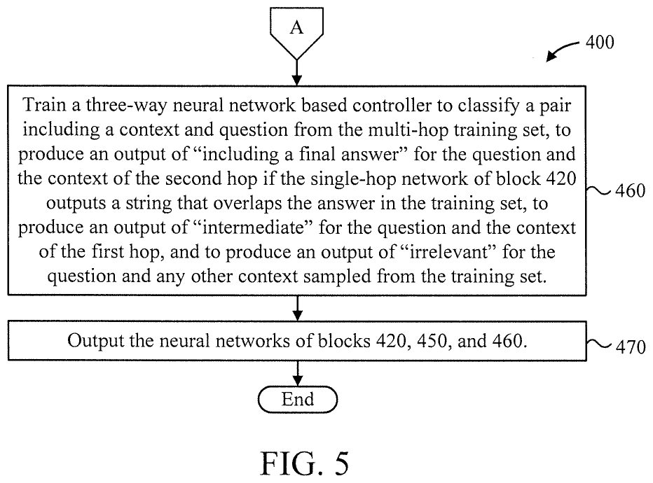

FIGS. 4-5 are flow diagrams showing an exemplary training method 400 for generating followup questions for interpretable recursive multi-hop question answering, in accordance with an embodiment of the present invention.

At block 410, collect a single-hop training set, including questions, single text contexts, and answers which are substrings of the contexts, and a multi-hop training set, including questions, pairs of text contexts, each called a hop, and answers which are substrings of the second hops.

At block 420, train a neural network for single hop question answering on the single-hop training set to predict answers given questions and contexts.

At block 430, train a neural network for question generation on the single-hop training set to predict questions given answers and contexts.

At block 440, apply the neural network for question generation of block 430 to the answers and context of the second hops in the multi-hop training set, to obtain weak ground truth followup questions.

At block 450, train a pointer-generator network to output the weak ground truth followup questions of block 440 given the original questions and context of the first hops in the multi-hop training set.

At block 460, train a three-way neural network based controller to classify a pair including a context and question from the multi-hop training set, to produce an output of “including a final answer” for the question and the context of the second hop if the single-hop network of block 420 outputs a string that overlaps the answer in the training set, to produce an output of “intermediate” for the question and the context of the first hop, and to produce an output of “irrelevant” for the question and any other context sampled from the training set.

At block 470, output the neural networks of blocks 420, 450, and 460. These neural networks can be used to solve question answering as in FIG. 3.

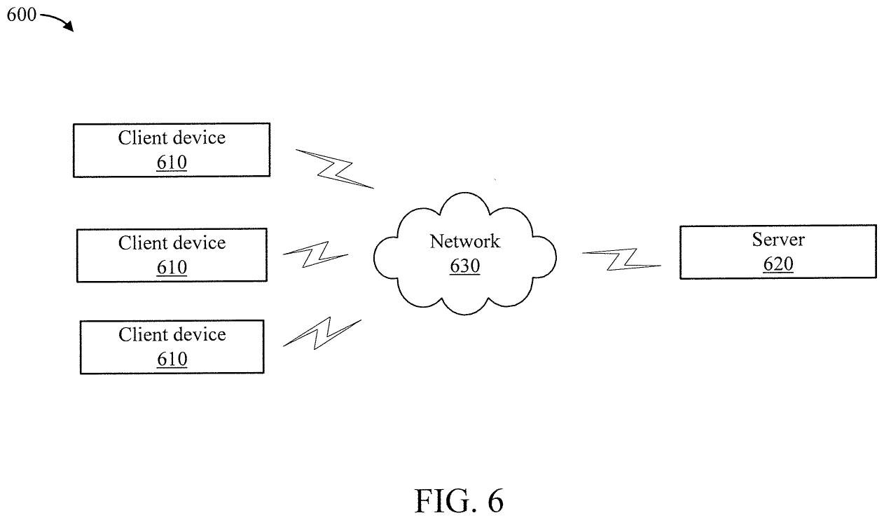

FIG. 6 is a block diagram showing an exemplary educational environment 600 to which the present invention can be applied, in accordance with an embodiment of the present invention.

The environment includes a set of client computers 610 and a server 620. The client computers 610 can be any of smart phones, tablets, laptops, desktops, and so forth.

Communication between the entities of environment 600 can be performed over one or more networks 630. For the sake of illustration, a wireless network 630 is shown. In other embodiments, any of wired, wireless, and/or a combination thereof can be used to facilitate communication between the entities.

The client computers 610 submit questions in order to obtain answers to those questions as well as follow-up questions for further learning in an educational environment. In this way, a student can be provided with additional new questions which are than answered to further the knowledge of the student with respect to a given subject matter relating to an initial question.

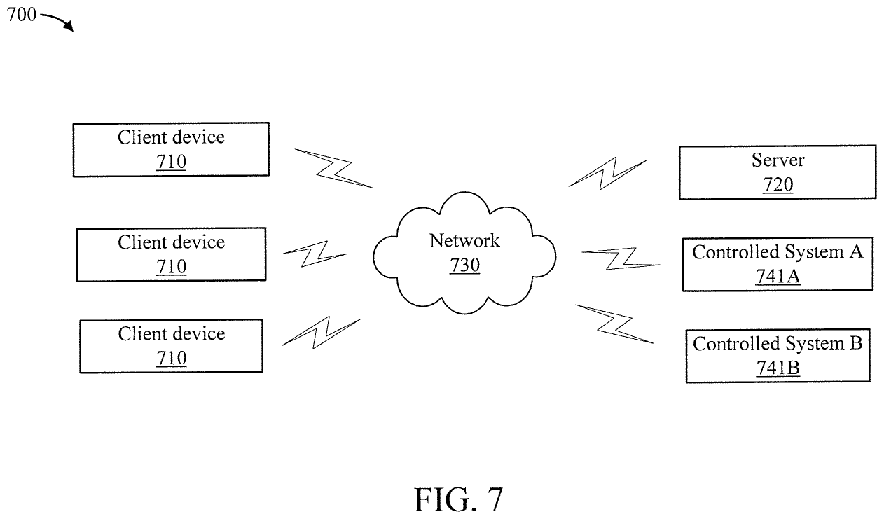

FIG. 7 is a block diagram showing an exemplary computing environment 600, in accordance with an embodiment of the present invention.

The environment 700 includes a server 710, multiple client devices (collectively denoted by the figure reference numeral 720), a controlled system A 741, a controlled system B 742.

Communication between the entities of environment 700 can be performed over one or more networks 730. For the sake of illustration, a wireless network 730 is shown. In other embodiments, any of wired, wireless, and/or a combination thereof can be used to facilitate communication between the entities.

The server 710 receives sequential data inputs from client devices 720. The server 710 may control one of the systems 741 and/or 742 based on a prediction generated from a disentanglement model stored on the server 710. In an embodiment, the sequential data inputs can relate to time series data that, in turn, relates to the controlled systems 741 and/or 742 such as, for example, but not limited to sensor data. Control can relate to turning an impending failing element off, swapping out a failed component for another operating component, switching to a secure network, and so forth.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for generating following up questions for multi-hop bridge-type question answering, the method comprising:
retrieving a premise for an input multi-hop bridge-type question;
assigning, by a three-way neural network based controller, a classification of the premise against the input multi-hop bridge-type question as being any of irrelevant, including a final answer, or including intermediate information;
outputting the final answer in relation to a first hop of the multi-hop bridge-type question responsive to the classification being including the final answer; and
generating a followup question by a neural network and repeating said retrieving, assigning, outputting and generating steps for the followup question, responsive to the classification being including the intermediate information.

2. The computer-implemented method of claim 1, further comprising retrieving another premise for the input multi-hop bridge-type question and repeating said assigning, outputting, and generating steps, responsive to the classification being irrelevant.

3. The computer-implemented method of claim 1, wherein the assigning neural network is trained using one or more cross-entropy losses for ternary classification.

4. The computer-implemented method of claim 1, wherein said generating step generates the followup question based on the input multi-hop bridge-type question and the retrieved premise for the input multi-hop bridge-type question.

5. The computer-implemented method of claim 1, wherein the generating neural network comprises a sequence-to-sequence model having a decoder configured to selectively generate a word from a fixed vocabulary or copy a word from the input multi-hop bridge-type question.

6. The computer-implemented method of claim 1, wherein the assigning step comprises a neural network including one or more self-attention layers.

7. The computer-implemented method of claim 1, wherein said outputting step is performed by a neural network that is trained for single hop question answering.

8. The computer-implemented method of claim 1, wherein the input multi-hop bridge-type question and the followup question are in natural text.

9. The computer-implemented method of claim 1, further comprising controlling a hardware object to perform a function based on the final answer.

10. A computer program product for generating following up questions for multi-hop bridge-type question answering, the computer program product comprising a non-transitory computer readable storage medium having program instructions embodied therewith, the program instructions executable by a computer to cause the computer to perform a method comprising:
retrieving a premise for an input multi-hop bridge-type question;
assigning, by a three-way neural network based controller, a classification of the premise against the input multi-hop bridge-type question as being any of irrelevant, including a final answer, or including intermediate information;
outputting the final answer in relation to a first hop of the multi-hop bridge-type question responsive to the classification being including the final answer; and
generating a followup question by a neural network and repeating said retrieving, assigning, outputting and generating steps for the followup question, responsive to the classification being including the intermediate information.

11. The computer program product of claim 10, further comprising retrieving another premise for the input multi-hop bridge-type question and repeating said assigning, outputting, and generating steps, responsive to the classification being irrelevant.

12. The computer program product of claim 10, wherein the assigning neural network is trained using one or more cross-entropy losses for ternary classification.

13. The computer program product of claim 10, wherein said generating step generates the followup question based on the input multi-hop bridge-type question and the retrieved premise for the input multi-hop bridge-type question.

14. The computer program product of claim 10, wherein the generating neural network comprises a sequence-to-sequence model having a decoder configured to selectively generate a word from a fixed vocabulary or copy a word from the input multi-hop bridge-type question.

15. The computer program product of claim 10, wherein the assigning step comprises a neural network including one or more self-attention layers.

16. The computer program product of claim 10, wherein said outputting step is performed by a neural network that is trained for single-hop question answering.

17. The computer program product of claim 10, wherein the input multi-hop bridge-type question and the followup question are in natural text.

18. The computer program product of claim 10, further comprising controlling a hardware object to perform a function based on the final answer.

19. A computer processing system for generating following up questions for multi-hop bridge-type question answering, the computer processing system comprising:
a memory device for storing program code; and
a processor device, operatively coupled to the memory device, for running the program code to
retrieve a premise for an input multi-hop bridge-type question;
assign, using a three-way neural network based controller, a classification of the premise against the input multi-hop bridge-type question as being any of irrelevant, including a final answer, or including intermediate information;
output the final answer in relation to a first hop of the multi-hop bridge-type question responsive to the classification being including the final answer; and
generate a followup question using a neural network and repeat the running of the program code to for the followup question, responsive to the classification being including the intermediate information.

20. The computer processing system of claim 19, wherein the assigning neural network is trained using one or more cross-entropy losses for ternary classification.
